(19) United States
(12) Patent Application Publication
(10) Pub. No.: US 2026/0317972 A1
(43) Pub. Date: Oct. 15, 2026

(54) BIOBASED BINDER COMPOSITIONS FOR NONWOVEN MATERIALS

(71) Applicant: ORGANOCLICK AB, Täby (SE)

(72) Inventors: Maria WENNMAN, Täby (SE); Marten HELLBERG, Enebyberg (SE)

(21) Appl. No.: 19/117,041

(22) PCT Filed: Nov. 3, 2023
(86) PCT No.: PCT/SE2023/051119

§ 371 Date: Mar. 29, 2025

(30) Foreign Application Priority Data
Nov. 3, 2022 (SE) 2251277-6

(51) Int. Cl. D04H 1/587; C08K 5/00; D04H 1/64; D04H 1/645; D04H 1/732

(52) U.S. Cl. CPC D04H 1/587; C08K 5/0016; D04H 1/643; D04H 1/645; D04H 1/732

(57) ABSTRACT

The present invention relates to biobased binder compositions which are environmentally benign, renewable, compostable and/or biodegradable. The biobased compositions comprise chitosan, an acid and a plasticizer. By treating a nonwoven material with a biobased binder according to the present invention, it is possible to provide a nonwoven material exhibiting excellent mechanical properties. The binder composition according to the present invention is easy to use for treatment of different types of nonwoven materials and can be adapted to provide specific properties to certain nonwoven materials and applications.

### TECHNICAL FIELD

The present invention relates to biobased binder compositions which are environmentally benign, renewable, compostable and/or biodegradable. The biobased compositions comprise chitosan, an acid and a plasticizer being a linear polyol and/or a non-macrocyclic saccharide. The invention further relates to a method of treating a nonwoven material with a biobased binder composition according to the present invention.

The compositions according to the present invention are suitable as a binder for different types of nonwoven materials. The treatment of various nonwoven materials with a binder composition according to the present invention provides nonwoven materials with excellent mechanical properties. In addition, the binder composition according to the present invention is easy to use for treatment of different types of nonwoven materials and can be adapted to provide specific properties to certain nonwoven materials and applications.

### BACKGROUND ART

Nonwoven materials are fabric-like materials made from long or short fibres, bonded together by a chemical, a mechanical, a heat or a solvent treatment. Nonwoven fabrics are also defined as sheet or web structures bonded together by entangling fiber or filaments (and by perforating films) mechanically, thermally or chemically. The term is used in the textile manufacturing industry to denote fabrics, such as felt, which are neither woven nor knitted. They are flat or tufted porous sheets that are made directly from separate fibres, molten plastic or plastic film.

Nonwoven materials can provide specific functions such as absorbency, water repellence, softness, strength, flame retardancy, cushioning, thermal insulation, acoustic insulation, filtration, bacterial barrier and sterility. These properties are often combined to create fabrics suited for specific applications, while achieving a good balance between product use-life and cost. They can mimic the appearance, texture and strength of a woven fabric and can be as bulky as a thick padding. In combination with other materials, they provide a spectrum of products with diverse properties, and are used alone or as components of apparel, home furnishings, health care, engineering, industrial and consumer goods.

Production of nonwoven materials starts with the arrangement of fibres into a web. There are different techniques for arranging the fibres, resulting in nonwoven materials with different properties, suitable for different applications. Examples of nonwovens produced by different techniques are wetlaid, airlaid, carded, spunlaid and airlay nonwovens. Webs may have a limited initial strength right after web formation and often need to be consolidated, by applying a binder to the web, by thermal treatment or by mechanical treatment. Further diversity can be added to nonwoven materials by a range of finishing treatments.

The principle for producing wetlaid nonwovens is similar to paper manufacturing. A dilute slurry of water and fibres is deposited on a moving wire screen, where the water is drained, and the fibres form a web. The web is further dewatered by pressing between rollers and dried. A binder is usually included during the process, using for example size press, spraying or addition to the paper slurry process to increase the strength of the nonwoven material.

In the airlaid process, a continuous web of fibres is formed using air as medium. Generally, fibres are dispersed in an air stream and deposited on for instance a moving wire. The resulting deposit is then compressed, for instance by pressure or vacuum. However, the material is at this stage totally unbonded since it cannot build up an internal strength as for example wetlaid nonwoven or paper can due to the hydrogen bonds formed in a wet process. In order to achieve bonding or other mechanical improvements in airlaid nonwovens, a binder is usually added and may be introduced at different stages in the manufacturing process depending on the type of binder used.

The production of carded nonwovens is a drylaid nonwoven process, i.e. dry fibres are blended, after which they are conveyed to a moving wire. They are then combed into a web by a carding machine, which is a rotating drum or series of drums covered by card wire (thin strips with teeth). The precise configuration of cards will depend on the type of fibre and the basis weight to be produced. Fibre bonding of carded nonwovens often involve hydroentanglement of the fibres with water jets with high pressure (spunlacing). Binders are also often added to the carded nonwoven material, in order to improve strength and/or other properties.

Traditionally, both liquid binders, slurries, suspensions, foams or powder binders have been used in the manufacturing of nonwoven materials. The most common bonding technique is the addition of a liquid binder to the nonwoven material, applied by, for example, impregnation, coating or spraying.

The addition of binders to different nonwoven materials improves the strength of the material, but it can also provide or improve other properties, like softness, flexibility, water repellence or antibacterial properties, that are desired in a particular nonwoven material or application.

The properties desired for a particular nonwoven material or in a particular application of a nonwoven material can be further tuned by adapting the add on, i.e. the level of application, of the binder composition.

One example of a desired property is softness in airlaid nonwoven materials used in the manufacturing of different hygiene products like disposable diapers, feminine hygiene articles, industrial or consumer wipes, wet wipes and napkins. Hygiene products are usually characterized by their bulkiness, softness and high water absorption. Elongation is a key requirement for these soft airlaid nonwoven materials. If too stiff, i.e. not flexible with a soft hand feel, the airlaid nonwoven will be perceived as unpleasant to the user. Elongation is also crucial during production of the airlaid nonwoven material and in the converting step to the final product (e.g. converting airlaid nonwoven to a napkin) as the machines induce high tensions in the material which require the material to have a high elongation in order not to break. Moreover, if the airlaid nonwoven material is not sufficiently strong and flexible, the material might break apart when used. To combine strength, soft hand feel and elongation is thus of crucial importance when developing airlaid nonwoven materials for these applications. Treatment of airlaid nonwoven materials with a composition according to the present disclosure will provide airlaid nonwoven materials which have the required softness, strength and elongation.

One example of a desired property of the binder composition itself is a good applicability of the binder to different nonwoven materials. Carded nonwoven materials are relatively dense and it can be challenging to achieve a satisfying application of a binder in a carded nonwoven material. One alternative for applying a binder in more challenging materials is to use foam impregnation. This requires that the binder is readily foamable with common foaming agents.

In an attempt to reduce the usage of synthetic binders, i.e. plastic binders, attention has been drawn to biobased polymers that can substitute the synthetic polymers used for nonwovens. Nevertheless, none of the alternatives so far can achieve a nonwoven article with such excellent mechanical properties in different kinds of nonwoven materials, while at the same time being so adaptable to provide the properties needed in a particular type of nonwoven material or application.

Previous attempts have been made to reduce or eliminate the usage of synthetic binders in nonwovens, such as in WO2020068151A1. However, the article disclosed in WO2020068151 A1 still comprises synthetic fibres and/or wet strength agents.

The use of chitosan as a binder component in nonwoven materials has been examined before, such as in WO2012015863A1. However, as clearly stated in WO2012015863A1, chitosan as the sole binder is not able to provide sufficiently good levels of mechanical properties such as for instance tensile strength. Therefore, a synthetic component, i.e. vinyl acetate ethylene, is provided in order to improve these properties as well as strength and elongation properties.

Bio-based polyelectrolyte complexes (PEC) have also been studied as an environmentally friendly binder alternative for materials such as fiber based materials, textiles, woven and nonwoven. PECs are association complexes formed between oppositely charged polycations and polyanions, formed due to electrostatic interaction between the oppositely charged polyions. Such a binder is for instance described in WO2018038671A1. However, a nonwoven treated with a PEC binder composition will not work in for example an airlaid nonwoven requiring a high softness, as it only shows an elongation, i.e. elongation at break, of around 3%. An elongation of around 5-9% is normally required for such applications.

There is thus still a need for a biobased binder composition suitable for use with different nonwoven materials and for different applications, providing excellent mechanical properties to the materials and also providing other properties required in a particular nonwoven material or application.

### SUMMARY OF INVENTION

An object of the present invention is to provide a biobased binder composition suitable as a binder for a nonwoven material.

An object of the present invention is to provide a biobased binder composition that is adaptable for treatment of different types of nonwoven materials.

A further object of the invention is to provide a biobased binder composition that provides excellent mechanical properties to different types of treated nonwoven material.

A further object of the invention is to provide a biobased binder composition that provides further properties to a treated nonwoven material.

A further object of the invention is to provide a biobased binder composition which gives sufficiently high elongation to a treated nonwoven material.

A further object of the invention is to provide a biobased binder composition which gives sufficiently high elongation to a treated airlaid nonwoven material.

A further object of the invention is to provide an airlaid nonwoven material which exhibits strength and sufficiently good elongation, preferably an elongation of at least 4%.

A further object of the invention is to provide a biobased binder composition that is easily applicable to different nonwoven materials.

A further object of the invention is to provide a biobased binder composition that provides excellent strength to a treated carded nonwoven material.

A further object of the invention is to provide a biobased binder composition that is environmentally friendly, renewable, compostable and/or biodegradable.

Any combination of the above objects is also possible.

In a first general aspect, the invention relates to an aqueous biobased binder composition for a nonwoven material, said composition comprising an acid, a plasticizer and a cationic polyelectrolyte comprising chitosan, and wherein,
the chitosan has a degree of deacetylation of 66-100%, and wherein the composition comprises 0.005-20 wt % of chitosan,
the acid in the aqueous binder composition is a Brønsted acid and/or a Lewis acid, wherein the Brønsted acid is selected from any organic and/or inorganic acids, wherein the Lewis acid is selected from any cationic mono- or multivalent atom, and wherein the aqueous binder composition comprises preferably 0.01-30 wt % of acid,
the aqueous binder composition comprises at least 0.5 wt % and less than 15 wt % of plasticizer, said plasticizer being a linear polyol selected from one or more of mannitol, maltitol, xylitol, and sorbitol and/or a saccharide being a non-macrocyclic saccharide selected from one or more of glucose, mannose, fructose, sucrose, sucralose, sucrose esters, hydrolysed starch or dextrin,
the pH of the aqueous binder composition is less than 7, and wherein the cationic polyelectrolyte is not in a complex with an anionic polyelectrolyte.

With an aqueous biobased binder composition according to the present disclosure, a binder for a nonwoven material comprising a high amount, or completely made of, renewable materials is achieved. A binder composition according to the present disclosure has been found to provide excellent mechanical properties in wetlaid, as well as in airlaid and carded nonwoven materials.

According to IUPAC-standard, by “macrocyclic” is meant a cyclic macromolecular or a macromolecular cyclic portion of a macromolecule. Examples of macrocyclic compounds are cyclodextrins.

The plasticizer is selected from a linear polyol and/or a non-macrocyclic saccharide. Without being bound to theory, such plasticizers are more flexible in their structure, thus resulting in a softer nonwoven material and a more efficient application within the nonwoven material fibre structure. A plasticizer being macrocyclic would result in a stiffer material. Moreover, macrocyclic compounds have a tendency to exhibit increased hydrophobic character which can be undesired in certain nonwoven applications.

The linear polyol is selected from one or more of mannitol, maltitol, xylitol and sorbitol. The saccharide being a non-macrocyclic saccharide is selected from one or more of glucose, mannose, fructose, sucrose, sucralose, sucrose esters, hydrolysed starch or dextrin.

In the context of the plasticizer, hydrolysed starch is a product from chemical or enzymatic treatment of starch from various natural sources. The hydrolysed starch can be hydrogenated and comprise a mixture of polyols. The hydrolysed starch is a source of sorbitol.

Furthermore, it has surprisingly been found that an aqueous binder composition according to the present invention is able to act as a binder in an airlaid nonwoven material, resulting in a material exhibiting both sufficiently high strength and elongation, compared to conventional synthetic binders used by the industry. Chitosan, compared to other cationic polyelectrolytes, imparts higher dry and especially wet tensile index to a material treated with the binder composition. Preferably, the binder composition comprises at least 50 wt % of biobased, i.e. of natural origin, components, more preferably at least 60 wt %, more preferably at least 70 wt %, even more preferably at least 80 wt % and most preferably at least 90 wt %.

Experiments have shown that a binder composition according to the present disclosure, comprising chitosan (cationic polyelectrolyte) without the presence of an anionic counter ion in the composition, can provide a better flexibility and softness to nonwoven materials, compared to a binder composition comprising polyelectrolyte complexes comprising cations and anions.

It has been found that in a binder composition according to the present disclosure, a cationic polyelectrolyte comprising chitosan, and substantially free from an anionic polyelectrolyte counter ion in the composition, is able to better spread within the nonwoven material, thus resulting in a more homogenous distribution. Without being bound by theory, it is believed that the lack of an electrostatic interaction between the cationic polyelectrolyte and an anionic polyelectrolyte, results in a cationic polyelectrolyte in a more expanded shape. If the cationic polyelectrolyte was to interact with an anionic counter component, the resulting polyelectrolyte complex would exhibit a more coiled structure. By achieving a more expanded shape, it is believed that the cationic polyelectrolyte is able to better spread within the nonwoven structure. This results in a stronger and more flexible nonwoven material, compared to if a PEC binder composition was used, as the chitosan will act as a binding component linking with itself as well as with fibres within the airlaid nonwoven material. The synergistic effect between the cationic polyelectrolyte comprising chitosan and the plasticizer results in a composition suitable as a binder for nonwovens that is able to achieve both strength as well as elongation of a treated material comparable to conventional synthetic binders used.

In one aspect, the aqueous binder composition is substantially free from anionic polyelectrolyte. If a substantial amount of an anionic polyelectrolyte would be present in the composition, the cationic and anionic polyelectrolyte would form a polyelectrolyte complex (PEC), resulting in an impaired functionality of the binder composition as previously described.

It is important that the pH is below 7 in the aqueous binder composition, as an acidic environment is needed for the chitosan to be in its cationic form. Preferably, the pH of the composition is lower than 6.5, preferably the pH of the composition is between 1.8-5.

In one aspect, the aqueous binder composition may further comprise a solvent selected from distilled water, tap water and deionized water.

The amount of each of the components of the aqueous biobased binder composition depends on the intended use of the composition and the required properties necessary for that use, such as for instance strength, softness, elongation, water repellence, absorbency, cushioning, insulation properties and/or filtration properties.

In one aspect, the aqueous binder composition comprises 0.01-11 wt %, such as 0.01-8 wt %, 0.01-5 wt % or 0.01-2 wt % of acid.

In one aspect, the aqueous binder composition comprises at least 0.05 wt % and less than 15 wt % of plasticizer. In one aspect, the aqueous binder composition comprises 0.05-14 wt % of plasticizer.

In one aspect, the aqueous binder composition comprises 2-14 wt %, preferably 5-14 wt %, of plasticizer, preferably 5-10 wt %.

In one aspect, the aqueous binder comprises at least 1 wt %, such as at least 2 wt %, and less than 15 wt % of plasticizer. In one aspect, the aqueous binder comprises 1-10 wt % of plasticizer.

In one aspect, the cationic polyelectrolyte in the aqueous binder composition consists of chitosan.

In one aspect, the aqueous binder composition comprises 0.005-10 wt % of chitosan, preferably 0.005-5 wt %, and even more preferably between 0.5-2.5 wt %. The wt % of chitosan is optimized based on the desired viscosity.

In one aspect, the acid is selected from one or more of acetic acid, acetylsalicylic acid, adipic acid, benzenesulfonic acid, camphorsulfonic acid, citric acid, citric acid monohydrate, dihydroxy fumaric acid, formic acid, glycolic acid, glyoxylic acid, hydrochloric acid, lactic acid, malic acid, malonic acid, maleic acid, mandelic acid, oxalic acid, para-toluenesulfonic acid, phtalic acid, pyruvic acid, salicylic acid, sulfuric acid, tartaric acid and succinic acid, preferably lactic acid.

In one aspect, the aqueous binder composition comprises chitosan as cationic polyelectrolyte, lactic acid as acid, and at least one of sorbitol, hydrolysed starch, xylitol and maltitol as plasticizer. Preferably, the plasticizer comprises hydrolysed starch.

In one aspect, the aqueous binder composition further comprises at least one or more of an additive selected from defoamer, foaming agent, wetting agent, coalescent agent, catalyst, surfactant, emulsifier, preservative, rheology modifiers, fillers, nonionic polymers, dye and pigment, wherein the concentration of the additive is 0-50 wt % by weight more preferably 0-30% by weight of the total weight of the composition. Said additives are selected depending on application method and expected final material properties.

The binder composition according to the present disclosure is easily applicable to different nonwoven materials, such as wetlaid, airlaid and carded nonwovens. For carded nonwoven materials, being relatively dense, foam impregnation is a suitable and energy efficient alternative for application of a binder. This requires that the binder is readily foamable with common foaming agents. The binder composition according to the present disclosure has proven to be easily foamable with common foaming agent and easy to apply to carded nonwovens by foam impregnation. Hence, treatment of carded nonwoven materials with a composition according to the present disclosure can provide carded nonwoven materials with excellent strength, derived from an efficient application of the binder to the material with foam impregnation.

In one aspect the aqueous binder composition comprises at least one foaming agent selected from one or more of an anionic surfactant, a cationic surfactant, a nonionic surfactant, and an amphoteric surfactant.

The catalyst can be chosen from Lewis bases and acids, such as clays, colloidal or noncolloidal silica, dialdehydes, organic amines, organic amides, quaternary amines, metal oxides, metal sulphates, metal chlorides, urea sulphates, urea chlorides and catalysts based on silicates.

The preservative can be selected from one or more of fungicide, bactericide, pharmaceutical preservative, cosmetic preservative and food preservatives. The inclusion of a preservative helps to inhibit the growth of mold in the binder composition.

The filler may be selected from one or more of gum arabic, konjac glucomannan, organic fillers such as wood flour, starch soy flour, olive seed flour, cork flour, corn cobs, rice brain husks, and inorganic fillers such as calcium carbonate, glass fibre, kaolin, talc and mice and other fillers known to the skilled person.

In one aspect, the aqueous binder composition comprises 0.5-2.5 wt % of chitosan, at least 2 wt % and less than 15 wt % of plasticizer, 0.05-3 wt % of acid and optionally 0.05-10 wt % of at least one or more of an additive selected from a defoamer, a foaming agent, a wetting agent, a coalescent agent, a catalyst, a surfactant, an emulsifier, a conservative, a cross-linker, a rheology modifier, a filler, a nonionic polymer, a dye and a pigment. In one further aspect, the plasticizer is present in an amount of 2-14 wt %.

In a second general aspect, the present invention is directed to a method of treating a nonwoven material with a biobased binder composition, wherein the method comprises the steps of:
a) providing a binder composition comprising an acid, a plasticizer and a cationic polyelectrolyte comprising chitosan, wherein the chitosan has a degree of deacetylation of 66-100%, the acid in the binder composition is a Brønsted acid and/or a Lewis acid, wherein the Brønsted acid is selected from any organic and/or inorganic acids, wherein the Lewis acid is selected from any cationic mono- or multivalent atom and wherein the cationic polyelectrolyte is not in a complex with an anionic polyelectrolyte;
b) optionally, diluting the binder composition provided in step a);
c) applying the composition of step a) or step b) to a nonwoven material by applying the binder composition on a formed nonwoven web, wherein the applied composition is a composition comprising 0.005-20 wt % of chitosan, at least 0.5 wt % and less than 15 wt % of plasticizer, wherein said plasticizer being a linear polyol selected from one or more of glycerol, mannitol, maltitol, xylitol, and sorbitol and/or a saccharide being a non-macrocyclic saccharide selected from one or more of glucose, mannose, fructose, sucrose, sucralose, sucrose esters, hydrolysed starch or dextrin, 0.01-30 wt % of acid and optionally 0.05-10 wt % of at least one or more of an additive selected from a defoamer, a foaming agent, a wetting agent, a coalescent agent, a catalyst, a surfactant, an emulsifier, a preservative, a cross-linker, a rheology modifier, a filler, a nonionic polymer, a dye and a pigment;
d) optionally curing the treated nonwoven material, preferably wherein the curing is performed at 20 to 200 degrees C.

The biobased binder composition applied may be any biobased binder composition according to the first aspect.

In one aspect, the nonwoven material treated according to the method disclosed in the present invention is selected from one or more of an airlaid nonwoven material, a wetlaid nonwoven material and a carded nonwoven material.

In one aspect, the nonwoven material is substantially based on natural fibres such as wood fibres (e.g. pulp), fluff pulp, hemp fibres, or man-made biobased fibres such as viscose, Iyocell and PLA.

By using a method according to the present invention, a nonwoven material is achieved exhibiting improved strength and elongation properties comparable to nonwovens bonded with conventional synthetic binders. This enables the substitution of conventional synthetic binders with a more environmentally friendly biobased alternative, without impairing the mechanical properties of the nonwoven material.

In one aspect of the invention, the binder composition in step b) is diluted to an aqueous binder composition comprising 0.5-2.5 wt % of chitosan, at least 2 wt % and less than 15 wt % of plasticizer, 0.05-3 wt % of acid and optionally 0.05-10 wt % of at least one or more of an additive selected from defoamer, foaming agent, wetting agent, coalescent agent, catalyst, surfactant, emulsifier, conservative, cross-linker, rheology modifiers, fillers, nonionic polymers, dye and pigment. In one further aspect, the binder composition is diluted so that the composition comprises 2-14 wt % plasticizer.

The binder composition can be applied by for instance spraying the binder composition on the nonwoven material, or by coating the binder composition on the nonwoven material, or by impregnating the binder composition on the nonwoven material or by foam-impregnating the binder composition on the nonwoven material.

In one aspect, the curing is performed at 20 to 200 degrees C. Preferably, the curing is performed above 135 degrees C., preferably above 150 degrees C.

In one aspect, the method results in higher elongation of the treated nonwoven, preferably the method results in an elongation of at least 4%, preferably at least 5%. As used herein, elongation means the total elongation at break measured according to standard Edana 20.2-89.

In third general aspect, the present invention is directed to a nonwoven material treated according to a method as defined in any of the previous aspects.

In one aspect, the nonwoven material exhibits an elongation of at least 4% after the treatment with an aqueous binder composition as defined in any one of the previous aspects. Preferably, the elongation is at least 5%. The elongation is measured according to Edana 20.2-89.

In another general aspect, the present invention is directed to use of an aqueous binder composition according to any one of the previous aspects for treating a nonwoven material. The use of the aqueous composition is preferably for providing excellent mechanical properties as well as other preferred properties to different kinds of nonwoven materials.

### DESCRIPTION OF EMBODIMENTS

In the following, a detailed description of the present invention is provided.

As used herein, “wt %” refers to weight percent of the ingredient, or ingredients, based on the total weight of the compound or composition.

As used herein, “about” refers to a measurable value, such as an amount, meant to encompass variations of +/−5% or less, even more preferably +/−1% or less, and still more preferably +/−0.1% or less of and from the specified value, in so far the skilled person understands that such variations are appropriate to perform in the disclosed invention. However, it is to be understood that the value to which “about” refers to is itself also specifically disclosed.

As used herein, a wetlaid nonwoven material is a nonwoven material produced by a wetlaid process. The wetlaid nonwoven can be produced with natural fibres such as wood fibres (e.g. pulp), fluff pulp, or hemp fibres, or man-made biobased fibres such as viscose, lyocell, PLA etc. A small or substantial amount of synthetic fibres such as PES, PET, PP etc. and also inorganic fibres such as glass fibres, can also be present in the wetlaid nonwoven material. The wetlaid nonwoven material can be used in, but are not limited to, applications such as tabletop products such as napkins, tablets or tablecloths, wipes and wet wipes, hygiene products such as diapers or femine hygiene products, agricultural nonwovens such as mulch films, air filtration materials, tea bags, coffee filters, food pads, geotextiles, and wallpapers.

As used herein, an airlaid nonwoven material is a nonwoven material produced by an airlaid (drylaid) process. The airlaid nonwoven can be produced by natural fibres such as wood fibres (e.g. pulp), fluff pulp, or hemp fibres or man-made biobased fibres such as viscose, lyocell, PLA etc. A small or substantial amount of synthetic fibres such as PES, PET, PP etc. can also be present in the airlaid nonwoven material. The airlaid nonwoven material can be used in, but are not limited to, applications such as hygiene applications such as baby diapers, feminine hygiene products, and adultery care products; tabletop products such as napkins or tablets, tablecloths; filter materials; automotive nonwovens; tea bags and coffee filters; medical nonwovens used for face masks, surgical gowns and hair covers; food packaging materials and food pads; wipes and wet wipes; and geotextiles.

As used herein, a carded nonwoven material is a nonwoven material produced by a carding process. The carded nonwoven can be produced by natural fibres such as wood fibres (e.g. pulp), fluff pulp, or hemp fibres or man-made biobased fibres such as viscose, lyocell, PLA etc. A small or substantial amount of synthetic fibres such as PES, PET, PP etc. can also be present in the carded nonwoven material. The carded nonwoven material can be used in, but are not limited to, applications such as hygiene applications such as baby diapers, feminine hygiene products, and adultery care products; filter materials; automotive nonwovens; tea bags and coffee filters; medical nonwovens used for face masks, surgical gowns and hair covers; food packaging materials and food pads; wipes and wet wipes; geotextiles; building materials for insulation and roofing; carpets, wallpapers, mattresses, and agricultural nonwovens.

As used herein, a surfactant is a molecule comprising a hydrophilic “head” and a hydrophobic “tail”.

As used herein a polyelectrolyte is a polymer whose repeating units bear a charged group.

The invention is further illustrated in the following examples, which do not limit the scope of the invention described in the claims.

### Experimental Section

Two different binder compositions, as defined in Table 1, were prepared.

TABLE 1
Binder compositions

| | Binder A | Binder B |
|---|---|---|
| RAW MATERIAL | wt % | wt % |
| Tap water | 61.41 | 60.61 |
| Hydrolyzed starch syrup | 35.00 | 35.40 |
| (70%) | | |
| Chitosan | 2.10 | 2.20 |
| Lactic acid (80%) | 1.40 | 1.40 |
| Acticide AB6 | 0.09 | 0.09 |
| NaCl | 0.00 | 0.30 |
| Sum | 100 | 100 |

### Example 1: Application of Binder a on Wetlaid Nonwoven Material by Spraying

A wetlaid material of unbonded cellulosic mixed fibres was used as substrate. The material was added on top of a conveyor belt running in different speeds (3, 5 and 7 m/min). Binder A was diluted from a dry weight of 26 wt % (measured with a moisture analyzer from VWR) to a dry weight of 2.5 wt % and sprayed on the wetlaid nonwoven material. The wetlaid nonwoven material was then cured, by passing through an oven that was 2 m long and heated to 160° C. After the treatment, the material was acclimatized overnight in 23° C. and 50% RH. Tensile testing was then performed on cut-out samples of 50 mm by 250 mm using a Testometric M250-2.5AT tensile testing machine. Seven specimen per trial was measured. Both a dry tensile test and a wet tensile test were performed. As a comparison, dry and wet tensile testing was performed on wetlaid nonwoven material without applied binder. For the wet tensile test, a Finish cup was used where the specimen was submerged in water for 15 s. Results from the dry tensile test can be found in Table 2 and from the wet tensile test in Table 3. All values are mean values.

TABLE 2
Dry tensile test. Test no 1 refers to the material without binder.

| | | Speed of | | | Tensile |
|---|---|---|---|---|---|
| Test | Binder | conveyer belt | Grammage | Elongation | index |
| point | add on | [m/min] | [g/m2] | [%] | [Nm/g] |
| 1 | No | — | 52.1 | 6.56 | 6.80 |
| 2 | Yes | 3 | 62.8 | 6.81 | 11.54 |
| 3 | Yes | 5 | 60.0 | 6.03 | 11.06 |
| 4 | Yes | 7 | 54.0 | 6.04 | 10.06 |

TABLE 3
Wet tensile test. Test no 1 refers to the material without binder.

| | | Speed of | | | Tensile |
|---|---|---|---|---|---|
| | Binder | conveyer belt | Grammage | Elongation | index |
| Test no | add on | [m/min] | [g/m2] | [%] | [Nm/g] |
| 1 | No | — | 52.6 | 8.96 | 2.43 |
| 2 | Yes | 5 | 55.8 | 8.82 | 7.05 |
| 3 | Yes | 7 | 53.0 | 8.45 | 5.26 |

From example 1, it can be concluded that the binder increases the mechanical properties of wetlaid nonwoven materials in both wet and dry conditions. The increase in tensile index required for a specific application can easily be tuned by adapting the add on of the binder composition.

### Example 2—Application of Binder B on Airlaid and Wetlaid Nonwoven Material by Impregnation

Binder B was diluted from a dry weight of 27 wt % (measured with a moisture analyser from VWR) to a dry weight of 14 wt % and added between two compressed rolls of a horizontal padder from Wichelhaus GmbH. The speed of the rolls was set to 11.6 m/min and the pressure between the rolls to 0.1 MPa. The material used in this study was airlaid nonwoven (fluff pulp fibers) and wetlaid nonwoven (mixed cellulosic fibers). After the impregnation, the material was put on a conveyer belt with the speed of 5 m/min which passed through a 3 m long oven heated to 160° C. The material was acclimatized overnight in 23° C. and 50%. Tensile testing was then performed on cut-out samples of 50 mm by 250 mm using a Testometric M250-2.5AT tensile testing machine. As a comparison, tensile testing was performed also on wetlaid and airlaid nonwoven material without applied binder. Ten specimen per trial were measured and the results from the tensile test can be found in Table 4. All values are mean values.

TABLE 4
Dry tensile test of wetlaid and airlaid nonwoven material

| | | | Tensile |
|---|---|---|---|
| | Grammage | Elongation | index |
| | [g/m2] | [%] | [Nm/g] |
| Wetlaid | 58.1 | 3.4 | 12.9 |
| Wetlaid with binder | 71.4 | 4.9 | 20.5 |
| Airlaid | 56.4 | 4.5 | 3.1 |
| Airlaid with binder | 66.8 | 5.4 | 13.4 |

It can be seen in Table 4 that both flexibility (elongation) and strength (tensile index) increase substantially, both in the wetlaid and in the airlaid nonwoven material. For the airlaid nonwoven material, it is noted that the elongation after application of the binder composition was 5.4%, hence the material meets the high requirements on flexibility needed in many applications where airlaid nonwovens are used.

### Example 3: Foamability of Binder a with Two Different Foaming Agents

The foamability of Binder A with two different foaming agents was evaluated. A nonionic foaming agent (Glucopone 215 UP) and a zwitterionic (amphoteric) foaming agent (Ammonyx LO) were tested.

Binder A was diluted from a dry weight of 26 wt % (measured with a moisture analyser from VWR) to a dry weight of 14 wt %. 100 g of the dilution of Binder A and 1 g of the respective foaming agent were added to a 250 ml beaker. The mixture was mixed with a propeller at 1500 rpm for 5 min. The height of the foam phase was measured directly after mixing and 5 minutes after finishing of the mixing. The results are shown in Table 5 below.

TABLE 5
Foam test of Binder A with different foaming agents

| | | Height | | |
|---|---|---|---|---|
| | | of added | Foam | Foam |
| | | binder in | height | height at |
| | | the beaker | at t = 0 | t = 5 min |
| Base | Additive | (cm) | (cm) | (cm) |
| Binder A | Glucopone | 3.3 | 4.6 | 4.0 |
| | 215 UP | | | |
| | (nonionic) | | | |
| Binder A | Ammonyx LO | 3.4 | 4.8 | 4.5 |
| | (zwitterionic) | | | |

The experiment showed that Binder A was foamable with both the tested foaming agents and that the foams keep stable for at least 5 minutes, which allows for a smooth application of the binder with foam impregnation.

### Example 4: Foam Impregnation of Binder a on Carded Nonwoven Material

Binder A was diluted from a dry weight of 26 wt % (measured with a moisture analyser from VWR) a dry weight of 10%. To 200 g of the dilution, 1.67 g Glucopon 215 UP (foaming agent, nonionic surfactant) was added, and the mixture was stirred vigorously at 2000 rpm with a disperser assembled on an overhead stirrer from IKA Werke for 60 s. A dense and stable foam was observed. The foam was added between two compressed rolls of a horizontal padder from Wichelhaus GmbH. The speed of the rolls was set to 11.6 m/min and the pressure between the rolls to 0.1 MPa. A carded viscose nonwoven was passed through the rolls. The nonwoven material was then dried in an oven from Termaks set at 170° C. for 3 min. The material was acclimatized overnight in 23° C. and 50% RH. Tensile testing was then performed on cut-out samples of 50 mm by 250 mm using a Testometric M250-2.5AT tensile testing machine. As a comparison, tensile testing was performed also on carded nonwoven material without applied binder. Eight specimen per trial was measured and the results from the tensile test can be found in Table 6. All values are mean values.

TABLE 6
Dry tensile test of carded nonwoven material

| | | | | Tensile |
|---|---|---|---|---|
| | | | Tensile | Stiffness |
| | Grammage | Elongation | index | index |
| | [g/m2] | [%] | [Nm/g] | [Nm/g] |
| Carded | 44.3 | 18.2 | 24.7 | 153.8 |
| Carded with | 46.1 | 6.5 | 27.6 | 1563.3 |
| foamed binder | | | | |

The carded viscose nonwoven is in itself very elastic due to the long staple fibres that are building up the material. By applying the binder composition, a stiffer, yet stronger, material can be achieved, which is clearly illustrated by the increase in tensile stiffness index in the carded nonwoven material treated with the foamed binder composition.

1. An aqueous biobased binder composition for a nonwoven material, said binder composition comprising an acid, a plasticizer and a cationic polyelectrolyte comprising chitosan, and wherein;
the chitosan has a degree of deacetylation of 66-100%, and wherein the binder composition comprises 0.005-20 wt % of chitosan;
the acid in the aqueous binder composition is a Bronsted acid and/or a Lewis acid, wherein the Bronsted acid is selected from any organic and/or inorganic acids, wherein the Lewis acid is selected from any cationic mono- or multivalent atom, and wherein the aqueous binder composition comprises 0.01-30 wt % of acid;
the aqueous binder composition comprises at least 0.5 wt % and less than 15 wt % of plasticizer, said plasticizer being a linear polyol selected from one or more of mannitol, maltitol, xylitol, and sorbitol, and/or a saccharide being a non-macrocyclic saccharide selected from one or more of glucose, mannose, fructose, sucrose, sucralose, sucrose esters, hydrolysed starch or dextrin;
a pH of the binder composition is less than 7, and wherein the cationic polyelectrolyte is not in complex with an anionic polyelectrolyte.

2. The aqueous binder composition according to claim 1, wherein the composition is substantially free from anionic polyelectrolyte.

3. The aqueous binder composition according to claim 1, wherein the composition comprises 0.01-11 wt % of acid.

4. The aqueous binder composition according to claim 1, wherein the composition comprises at least 1 wt % of plasticizer.

5. The aqueous binder composition according to claim 1, wherein the composition comprises 0.005-10 wt % of chitosan.

6. The aqueous binder composition according to claim 1, wherein the acid is selected from one or more of acetic acid, acetylsalicylic acid, adipic acid, benzenesulfonic acid, camphorsulfonic acid, citric acid, dihydroxy fumaric acid, formic acid, glycolic acid, glyoxylic acid, hydrochloric acid, lactic acid, malic acid, malonic acid, maleic acid, mandelic acid, oxalic acid, paratoluenesulfonic acid, phtalic acid, pyruvic acid, salicylic acid, sulfuric acid, tartaric acid and succinic acid, preferably lactic acid.

7. The aqueous binder composition according to claim 1, wherein the composition further comprises at least one additive selected from one or more of a defoamer, a foaming agent, a wetting agent, a coalescent agent, a catalyst, a surfactant, an emulsifier, a preservative, a cross-linker, a rheology modifier, a filler, a nonionic polymer, a dye and a pigment and wherein the concentration of the additive is 0-50% by weight.

8. The aqueous binder composition according to claim 1, wherein the composition further comprises at least one foaming agent selected from one or more of an anionic surfactant, a cationic surfactant, a nonionic surfactant and an amphoteric surfactant.

9. The aqueous binder composition according to claim 1, wherein the composition comprises 0.5-2.5 wt % of chitosan, at least 2 wt % and less than 15 wt % of plasticizer, and 0.05-3 wt % of acid.

10. A method of treating a nonwoven material with a biobased binder composition, wherein the method comprises the steps of:
a) providing a binder composition comprising an acid, a plasticizer and a cationic polyelectrolyte comprising chitosan, wherein the chitosan has a degree of deacetylation of 66-100%, the acid in the binder composition is a Bronsted acid and/or a Lewis acid, wherein the Bronsted acid is selected from any organic and/or inorganic acids, wherein the Lewis acid is selected from any cationic mono- or multivalent atom and wherein the cationic polyelectrolyte is not in a complex with an anionic polyelectrolyte;
b) applying the composition of step a) to a nonwoven material by applying the binder composition on a formed nonwoven web, wherein the applied composition is a composition comprising 0.005-20 wt % of chitosan, at least 0.5 wt % and less than 15 wt % of plasticizer, wherein said plasticizer being a linear polyol selected from one or more of glycerol, mannitol, maltitol, xylitol, and sorbitol and/or a saccharide being a non-macrocyclic saccharide selected from one or more of glucose, mannose, fructose, sucrose, sucralose, sucrose esters, hydrolysed starch or dextrin, 0.01-30 wt % of acid.

11. The method according to claim 10, wherein the nonwoven material is selected from one or more of an airlaid nonwoven material, a wetlaid nonwoven material and a carded nonwoven material.

12. The method according to claim 10, wherein the nonwoven material is substantially based on natural fibers or man-made biobased fibers.

13. The method according to claim 10, wherein the binder composition is applied to the nonwoven material by spraying the binder composition on the nonwoven material, by coating the binder composition on the nonwoven material, by impregnating the binder composition on the nonwoven material or by foam-impregnating the binder composition on the nonwoven material.

14. (canceled)

15. A nonwoven material treated according to the method as defined in claim 10.

16. (canceled)

17. Use of an aqueous binder composition according to claim 1 for treating a nonwoven material.

18. The aqueous binder composition according to claim 9, wherein the composition comprises 0.05-10 wt % of at least one or more of an additive selected from a defoamer, a foaming agent, a wetting agent, a coalescent agent, a catalyst, a surfactant, an emulsifier, a preservative, a cross-linker, a rheology modifier, a filler, a nonionic polymer, a dye, and a pigment.

19. The method according to claim 10, comprising a step of diluting the binder composition provided in step a) prior to step b).

20. The method according to claim 10, comprising a step c) comprising curing the treated nonwoven material, wherein the curing is performed at 20 to 200 degrees C.

21. The method according to claim 10, wherein the composition comprises 0.05-10 wt % of at least one or more of an additive selected from a defoamer, a foaming agent, a wetting agent, a coalescent agent, a catalyst, a surfactant, an emulsifier, a preservative, a cross-linker, a rheology modifier, a filler, a nonionic polymer, a dye and a pigment.
